(19) United States
(12) Patent Application Publication
(10) Pub. No.: US 2019/0120385 A1
(43) Pub. Date: Apr. 25, 2019

(54) SHAFT SEAL WITH HELICAL SEALING LIP

(71) Applicant: System Seals, Inc., Cleveland, OH (US)

(72) Inventors: Arnold A. W. J. von Engelbrechten, Cleveland Heights, OH (US); Ronald G. Claus, Medina, OH (US)

(73) Assignee: System Seals, Inc., Cleveland, OH (US)

(21) Appl. No.: 16/165,616

(22) Filed: Oct. 19, 2018

Related U.S. Application Data
(60) Provisional application No. 62/574,494, filed on Oct. 19, 2017.

(51) Int. Cl. F16J 15/3232; F16J 15/3244; F16J 15/324; F16J 15/3284; F16J 15/3252

(52) U.S. Cl. CPC F16J 15/3232; F16J 15/3244; F16J 15/3268; F16J 15/3284; F16J 15/3252; F16J 15/324

(57) ABSTRACT

A seal includes an annular body defining an opening for a shaft. At least one sealing lip is connected to an inner wall of the body and projects inwardly toward a central axis. The one or more sealing lips each include an outer edge connected to the inner wall of the body and an inner edge that is spaced inwardly toward the central axis. Each sealing lip extends helically about the central axis. If multiple sealing lips are provided, each extends helically about the central axis with the same orientation but they are axially offset with respect to each other. One or more helically extending lubricant channels are defined by the helical sealing lip(s) and pump lubricant inwardly upon relative rotation between the seal and shaft. An optional debris lip is located between the flexible sealing lip(s) and the front face of the seal body to inhibit ingress of contaminants.

### CROSS-REFERENCE TO RELATED APPLICATION

This application claims priority from and benefit of the filing date of U.S. provisional application Ser. No. 62/574,494 filed Oct. 19, 2017, and the entire disclosure of said provisional application is hereby expressly incorporated by reference into the present specification.

### BACKGROUND

A wide variety of seals are well-known and in widespread use for engaging a rotating shaft to inhibit egress of grease and/or other lubrication with respect to a bearing or other sealed internal region of a housing to which the seal is connected. One such application for such seals is sealing the bearings of the input shaft of a wind turbine.

Known seals for wind turbines and similar applications have been found to be suboptimal for different reasons. As wind turbines continue to increase in size, the correspondingly larger bearings exhibit greater radial and axial deflections which can cause the rotating shaft to become misaligned with respect to the seal. Known seals such as single-lip seals are sometimes unable to accommodate the shaft deflection while maintaining an effective seal against the outer surface of the shaft which can allow contaminates to move past the seal into the bearing and which can also allow grease or other lubricate to escape the bearing. With a single-lip seal, once the lubricant moves out of the bearing region past the seal lip, the lubricant cannot be recovered by the seal.

Another drawback of known single-lip seals is that they operate with a single line of contact on the rotating shaft. As such, effective sealing requires that the outer surface of the shaft in the region to be contacted by the seal be specially ground and/or polishes to ensure a high-quality and long-lasting interface between the lip of the seal and the outer surface of the rotating shaft.

Known seals are also problematic with respect to their replacement in the field. For wind turbines and many other applications, it is necessary to split a replacement seal to install the replacement seal around a shaft. When the new seal is coaxially positioned about the shaft, the split must be repaired/closed by adhesive, vulcanization, or other bonding means/methods. Any misalignment during the split repair/closing procedure will result in a defective sealing lip that will leak at the locations where the split ends of the lip are connected together.

In light of the foregoing, a need has been identified for a new and unobvious seal that overcomes the above deficiencies and others associated with known seals in order to provide an effective seal that accommodates shaft misalignment, that reduces or eliminates the need to polish or grind the outer surface of the shaft, and that is effective even after being split and repaired during a seal replacement operation.

### SUMMARY

In accordance with one aspect of the present development, a seal includes a body comprising a rear face, a front face, an outer wall, and an inner wall that defines an opening in the body that is adapted to receive an associated shaft. The opening is defined about a central longitudinal axis of the body. At least one flexible sealing lip is connected to the inner wall and projects inwardly from the inner wall toward the central longitudinal axis. The (or each) sealing lip includes an outer edge connected to the inner wall of the body and also includes an inner edge that is spaced inwardly toward the central longitudinal axis relative to the outer edge. The (or each) flexible sealing lip extends helically about the central longitudinal axis.

In accordance with another aspect of the present development, a seal installation includes a housing and a shaft supported relative to the housing for relative rotation between the shaft and the housing about an axis of rotation. The housing includes a seal-receiving region coaxially located about the axis of rotation. A seal is installed in the seal-receiving region and coaxially located about the axis of rotation. The seal includes a body with a rear face, a front face, an outer wall, and an inner wall that defines an opening in the body through which the shaft extends, said opening defined about a central longitudinal axis of the body. At least one flexible sealing lip is connected to the inner wall of the seal body and projects inwardly from the inner wall toward the axis of rotation. The at least one flexible sealing lip includes an outer edge connected to the inner wall of the body and comprising an inner edge that is spaced inwardly toward the axis of rotation and in contact with an outer surface of the shaft. The at least one flexible sealing lip extends helically about the central longitudinal axis and defines a helically extending lubricant channel, wherein lubricant located in the lubricant channel is pumped toward an internal region of the housing away from the front face of the seal body upon relative rotation between the shaft and the housing.

### BRIEF DESCRIPTION OF DRAWINGS

FIG. 1 is an isometric view of a seal S formed in accordance with an embodiment of the present development;

FIG. 2 provides a sectioned view of the seal S;

FIGS. 3 and 4 provide front and rear views of the seal S, respectively;

FIGS. 5 and 6 are section views that show the seal S operatively installed with respect to an associated housing H and shaft T, with the seal S arranged or located in either a first operative configuration as shown in FIG. 5 (with its rear/inner face IF directed inwardly) or a second operative configuration as shown in FIG. 6 (with its front/outer face OF oriented inwardly);

FIG. 7 provides a section view of the seal S and includes a diagrammatic illustration of the auger effect or pumping effect of the seal lip when the seal S is in operative use;

FIG. 8 is an isometric view of a seal S′ formed in accordance with an alternative embodiment;

FIG. 9 is a section view of the seal S′;

FIGS. 10 and 11 provide are respective front and rear views of the seal S′.

### DETAILED DESCRIPTION

The present development relates to a seal adapted to be engaged with a rotating shaft to inhibit ingress of liquid and particulate contamination with respect to a bearing or other sealed internal region of a housing, and to actively pump grease, oil or another lubricate axially inward with respect to the axis of the rotating shaft toward the bearing or sealed region.

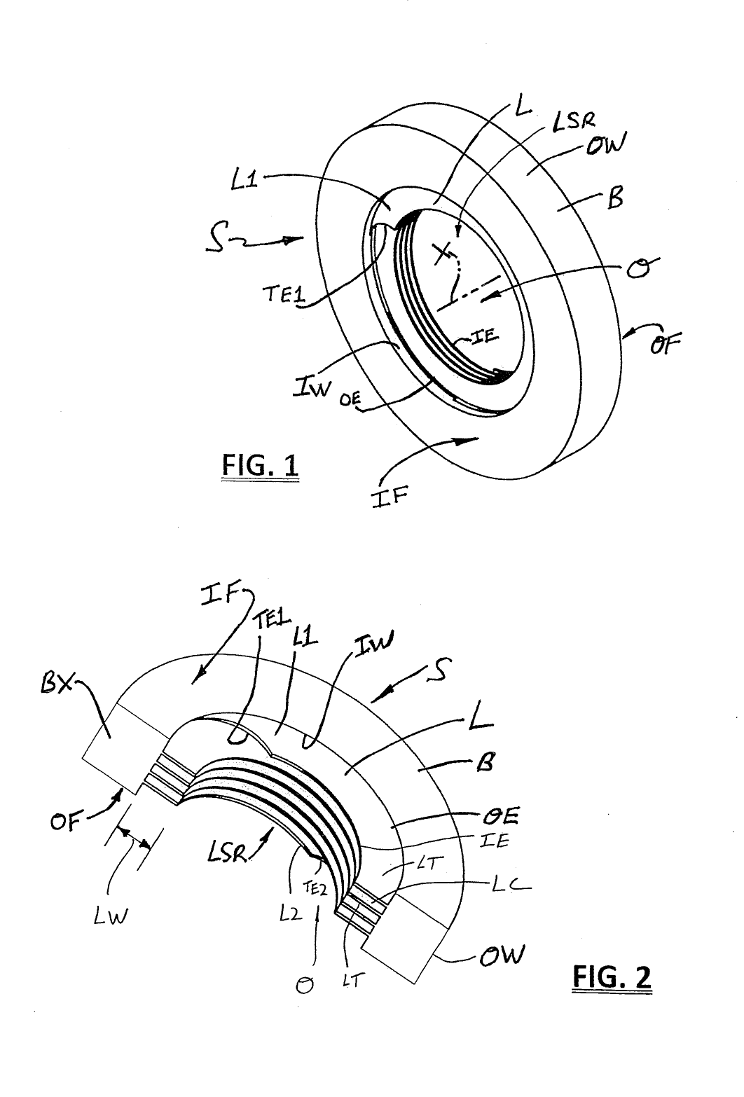

Referring to FIGS. 1-4, an example of a seal S formed in accordance with an embodiment of the present development is shown and comprises a one-piece construction of polymeric material such as polyurethane, polyethylene, polytetrafluoroethylene (PTFE) or any other suitable flexible plastics or elastomeric or polymeric material. The seal S includes an outer annular body B comprising a continuous, uninterrupted annular or circular ring of any desired cross-section BX such as the rectangular cross-section as shown herein.

The body includes a central opening O that extends there through and that is defined about a central longitudinal axis X of the body B. The opening O is adapted to receive an associated rotating shaft as described in detail below.

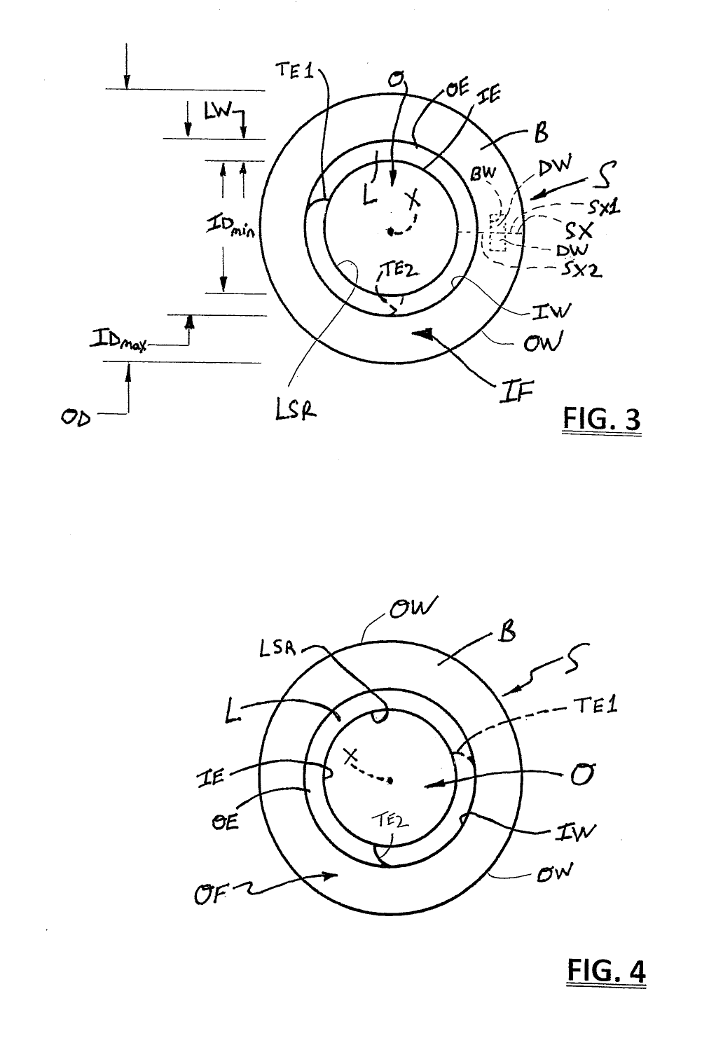

The body B includes an outer cylindrical peripheral wall OW formed concentrically about the central longitudinal axis X such that the outer wall OW defines an outside diameter OD of the body (see FIG. 3) and seal S. The body B also includes an inner cylindrical bore wall IW formed concentrically about the longitudinal axis X radially inward with respect to the outer wall OW. The inner wall IW defines the opening O in the body B and defines a maximum inside diameter IDₘₐₓ of the body B and seal S. The body B further includes a rear or inner axial face IF that extends between the outer wall OW and inner wall IW on a rear or inner axial side or end of the body B, and the body B similarly includes a front or outer axial face OF that extends between the outer wall OW and the inner wall IW on a front or outer axial side or end of the body B that is opposite the inner axial side/end of the body B. The inner (rear) and outer (front) faces IF,OF are parallel and spaced-apart from each other. The opening O extends axially between the inner and outer faces IF,OF and defines an axial length OL (FIG. 2) equal to the axial length of the inner bore wall IW measured between the inner and outer faces IF,OF parallel to the central longitudinal axis X.

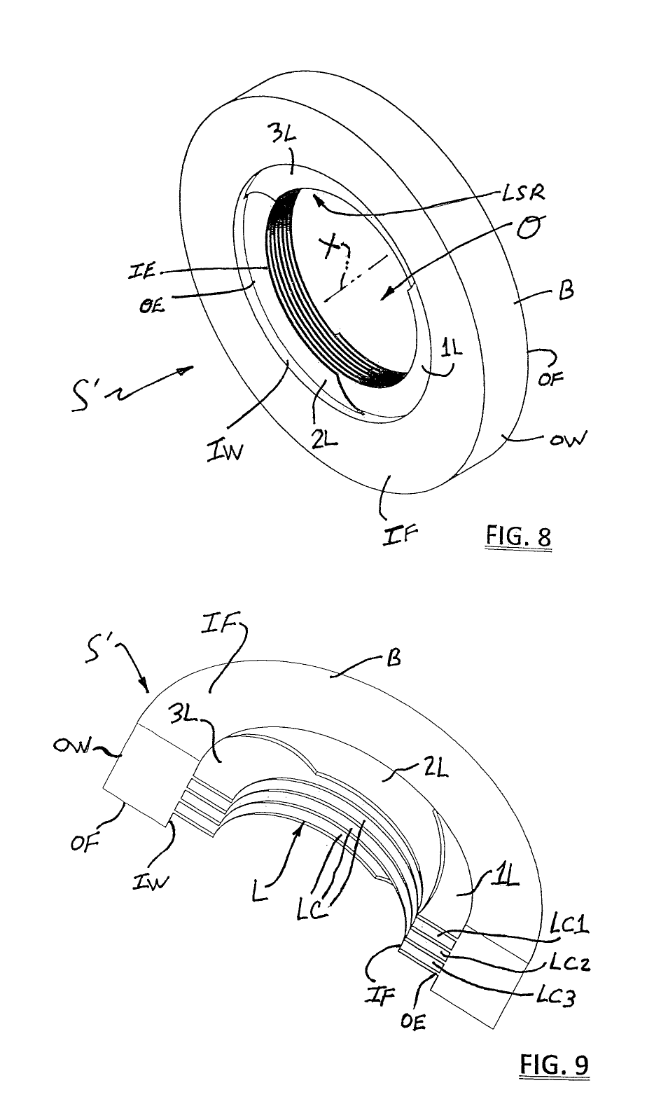

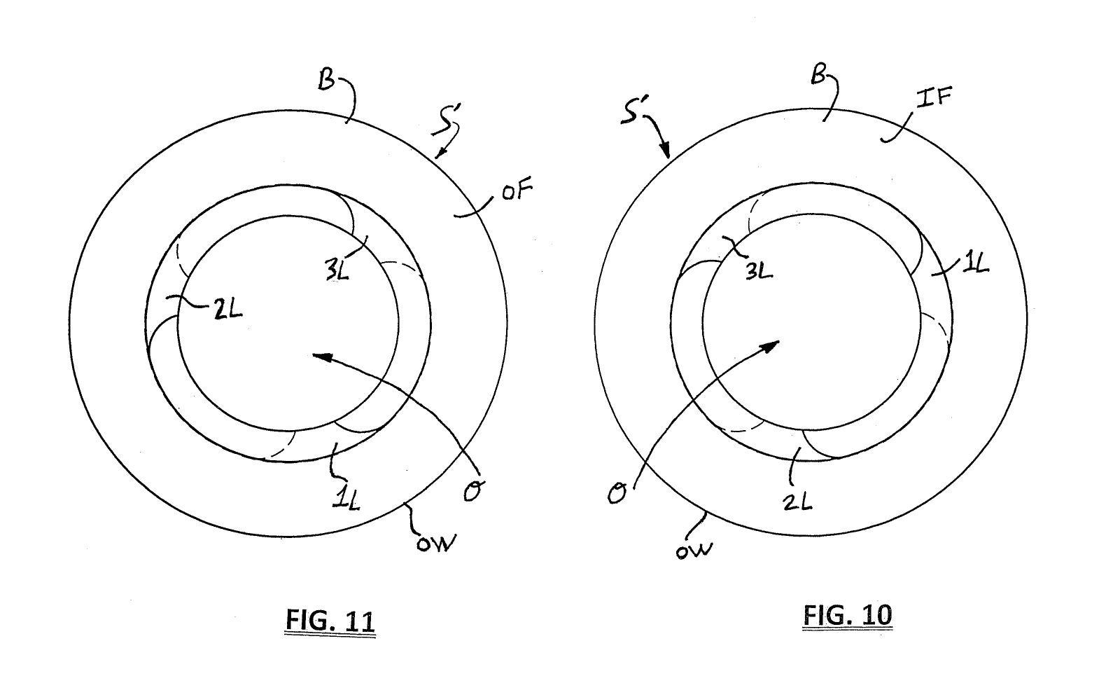

The seal S further comprises a flexible sealing lip L (or multiple lips L as described below in relation to FIGS. 8-11) connected to the inner bore wall IW and projecting radially inward from the inner bore wall IW toward the central longitudinal axis X. More specially, in the illustrated embodiment, the lip L comprises a continuous, uninterrupted flexible strip including an outer edge OE that is connected to the inner bore wall IW. The lip L further comprises an inner edge IE that that is spaced radially inward from the lip outer edge OE. The lip L thus defines a radial lip width LW (FIG. 2) between its outer and inner edges OE,IE. The lip L can have any desired cross-sectional thickness measured parallel to the longitudinal axis X, including a variable thickness that decreases or otherwise changes as the lip L extends radially inward away from the inner bore wall IW, provided that at least the inner edge IE of the lip L is flexible in opposite axial directions toward and away from the inner and outer faces IF,OF of the seal S. Since the outer edge OE of the lip L is connected to the inner bore wall IW, the outer edge OE of the lip L is located entirely between the inner and outer faces IF,OF of the seal S. When the seal is uninstalled and in an undisturbed rest or “free” position where the lip L is undeflected from its natural position, the lip L of the illustrated seal S is contained entirely in the opening O between the inner and outer faces IF,OF such that no part of the lip L extends axially outside the opening O beyond the inner and/or outer faces IF,OF of the seal body B. In the illustrated embodiment, the lip Lis flat or planar between its outer and inner edges OE,IE, but the lip L can alternatively include a curved portion such as a curved inner edge IE.

The outer edge OE of the lip L extends along the cylindrical inner bore wall IW in a helical path or spiral path centered at the longitudinal axis X such that the inner edge IE and the entire lip L, itself, extends along the same helical or spiral path about the longitudinal axis X and such that the inner edge IE of the lip L follows a helical path centered on the longitudinal axis X. In one embodiment, the lip L extends around the longitudinal axis at least one (1.0) complete helical turn and preferably at least one-and-one-half (1.5) complete turns LT, and more preferably at least three (3) complete turns LT, but more than three or fewer than three complete turns LT can alternatively be provided. In the illustrated example, the lip L makes more than four complete helical turns LT about the longitudinal axis X.

The lip L includes a first end or inner end L1 where it starts or begins and an opposite second or outer end L2 where it ends or terminates, and it extends continuously and uninterruptedly along a helical or spiral path between its first and second ends L1,L2. The first end L1 of the lip is located closer to the body inner face IF as compared to the outer face OF, and the opposite second or outer end L2 of the lip is located closer to the body outer face OF as compared to the inner face IF.

As the lip L extends helically between its first (inner) and second (outer) ends L1,L2, the lip L preferably includes a constant lip width LW (FIG. 2). As such, the lip inner edge IE defines a cylindrical lip seal region LSR that defines a minimum inside diameter IDₘᵢₙ (FIG. 3) of the seal S, and an associated shaft to be sealed must have an outside diameter greater than the minimum inside diameter IDₘᵢₙ for the seal S to operate as described herein. The lip width LW=IDₘₐₓ−IDₘᵢₙ as shown in FIG. 3.

Between axially successive turns LT of the sealing lip L, an open, helically extending lubricant channel LC (FIG. 2) is defined and extends continuously and uninterrupted along a helical path centered on said longitudinal axis X between the first and second opposite ends L1,L2 of the sealing lip L. The lubricant channel LC is bounded or closed on its opposite axial sides by the lip L (i.e., by axially successive portions or turns of the lip L), and is bounded or closed at its radially outermost end by the inner cylindrical wall IW. The lubricant channel LC is open on its radially innermost end and opens into the cylindrical lip seal region LSR when the seal S is not in operative use.

In the illustrated embodiment, the outer and inner ends L1,L2 of the lip L are formed with respective transition edges TE1,TE2 where the lip width LW is gradually decreased from its maximum magnitude (i.e., LW) to zero as the lip extends helically. The transition edges TE1,TE2 can be linear or are curved, such as with a concave curvature as shown, a convex curvature, or with a combination of curved shapes.

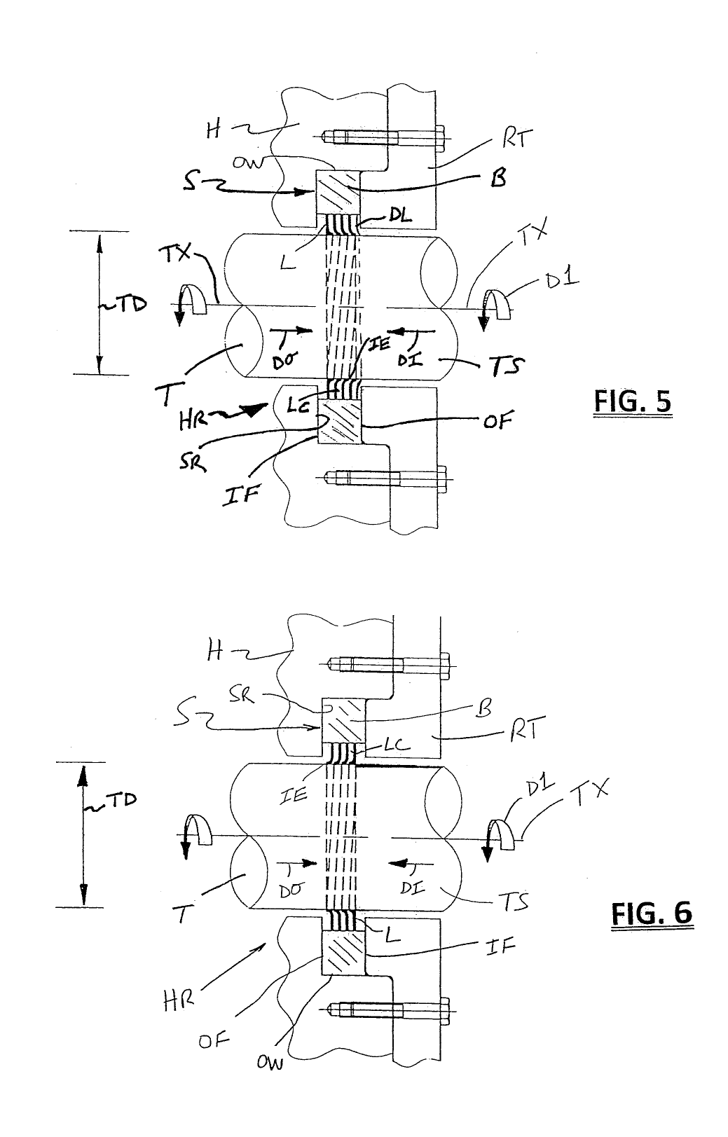

FIGS. 5 and 6 are section views of a seal installation that show the seal S operatively installed with respect to an associated housing H and shaft T that is rotatably supported relative to the housing H for rotation about an axis of rotation TX. In an alternative embodiment, the housing H rotates relative to the shaft T about the axis of rotation TX, or both the housing H and shaft T are rotatable relative to each other about the axis of rotation TX. The housing H includes a cylindrical seal-receiving cup or region SR that is coaxially located about the axis of rotation TX. The seal body B is closely and non-rotatably installed with a fluid-tight fit in the seal-receiving region SR of the housing H such that that the longitudinal axis X of the seal S is coincident with the axis of rotation TX whereby the seal S is coaxially arranged about the shaft T. If the seal S does not include the optional debris lip DL shown in FIG. 5 and discussed further below, the seal S is reversible in the sense that it can be arranged with either its inner face IF oriented inwardly toward an internal region HR housing H that includes a bearing or other protected structure to be sealed as shown in FIG. 5, or the seal S can alternatively be arranged in the opposite orientation with its outer face OF oriented inwardly toward the internal housing region HR as shown in FIG. 6. An annular or otherwise shaped seal cap or retainer RT is bolted or otherwise affixed to the housing H adjacent the seal-receiving region SR and captures the seal body B in the seal-receiving region SR.

The shaft T includes a cylindrical outer surface TS that defines an outside diameter TD that is greater than the minimum inside diameter IDₘᵢₙ defined by the inner edge IE of the seal lip L, at least where the lip L contacts the outer surface TS of the shaft T. As such, the seal lip L deflects in either a first (outward) axial direction as shown in FIG. 5, which is typically when the seal S is installed, or the seal lip L deflects in a second (inward) axial direction as shown in FIG. 6. In either the arrangement of FIG. 5 or the arrangement of FIG. 6, the helically extending lubricant channel LC defined between successive turns LT of the sealing lip L is present and is closed at its radially inward side or end by the outer surface TS of the shaft.

FIG. 5 shows the seal S including an optional flexible debris lip DL (not shown in FIG. 6) located in the opening O between the outer face OF and the helical lip L. The debris lip DL is preferably a circular (non-helical) continuous, circumferentially uninterrupted lip that projects inwardly from the inner wall IW of the body B into the opening O toward the central axis X and that engages the outer surface TS of the shaft T to inhibit entry of water, dust, and other debris or contaminants into the lubricant channel LC. When the seal S includes the optional debris lip DL, the seal must be installed in the housing H as shown in FIG. 5, with the debris lip DL oriented outwardly with respect to the housing inner region HR, so that the debris lip DL does not impede the pumping action of the seal S as it pumps lubricant toward the housing inner region HR.

With continuing reference to FIGS. 5 and 6, it should be noted that a main advantage of the seal S is that the seal S can be axially pushed into the seal-receiving region SR of the housing and the sealing lip L assumes its operative position as shown in FIG. 5 (typical) or FIG. 6 without requiring the use of special tools to manipulate the sealing lip L after the seal is installed in the seal-receiving region SR about the shaft T. The seal S automatically and naturally or spontaneously assumes its operative position as shown in FIG. 5 or FIG. 6 merely by being pushed into the seal-receiving region SR. This is due in part to the fact that, unlike known seals with a long, tapered, flexible sleeve-like sealing lip that extends axially outward from the main body of the seal and engages the shaft in a cuff-like arrangement, the sealing lip L of the present seal S is contained within the opening O and does not project axially outward from the opening O beyond the inner (rear) face IF or outer (front) face OF of the body B.

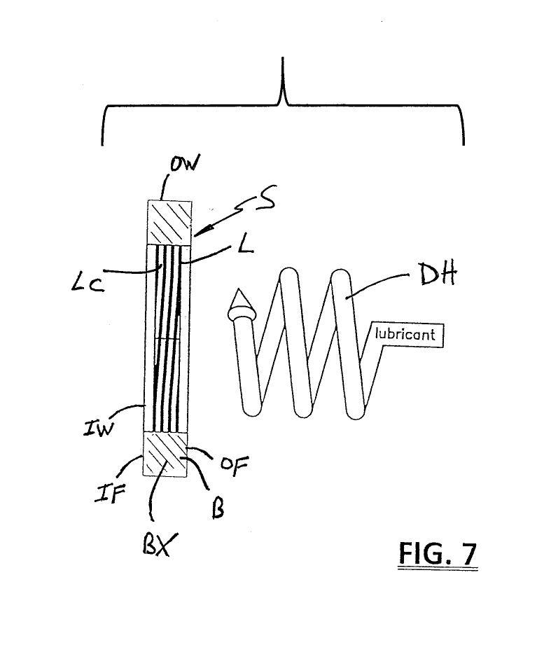

In use of the seal S, the spiral or helical sealing lip L acts as an auger or pump when the shaft T rotates about the axis of rotation TX (and/or when the housing H rotates about the axis or rotation TX relative to the shaft T in an opposite angular direction) to inhibit loss of lubricant such as oil or grease and to actively pump the lubricant axially inward toward the internal region HR of the housing H. As shown with reference also to FIG. 7, the lubricant channel LC defined between axially successive helical turns of the lip L is oriented such that upon rotation of the shaft T in a first angular direction D1 about its axis of rotation TX (see FIGS. 5 & 6 wherein the first direction D1 is a clockwise direction of shaft rotation when viewed from the outside of the housing H looking toward the internal region HR of the housing H) and/or upon rotation of the housing H relative to the shaft T in a second direction opposite the first direction D1, any oil, grease, or other lubricant located on the outer surface TS of the shaft T in the lubricant channel LC is actively urged or pumped inwardly in an inward direction DI while following the helical path of the lubricant channel LC toward the internal region HR of the housing H is indicated by the arrow DH in FIG. 7. Thus, in the case where lubricant moves between the shaft outer surface TS and the inner edge IE of one or more turns LT of the sealing lip L in an outward direction DO due to pressure or other cause, the auger or pumping action of the helical sealing lip L when the shaft T rotates in the first direction D1 and/or when the housing H rotates relative to the shaft T in a second direction opposite the first direction D1 returns any lubricant in the lubricant channel LC back into the housing internal region HR in the direction DI along the helical path DH in the lubricant channel LC.

The sealing lip L follows either a right-handed helical path (also referred to herein as right-handedness or a right-handed orientation or right-hand chirality as shown herein) or a left-handed helical path (also referred to herein as left-handedness or a left-handed orientation or left-hand chirality as shown herein) depending upon the specified direction of rotation of the shaft T for a given application. In the case when the shaft T rotates in a second angular direction that is opposite the angular direction D1 and/or when the housing H rotates about the shaft T in the first angular direction D1, the seal S is provided with a helical lip L with a left-handed orientation or path (opposite to that shown herein) so that lubricant in the lubricant channel LC is pumped in the inward direction DI toward the housing internal region HR. It should be noted that, for a given direction of relative rotation between the shaft T and housing H, the lubricant will be pumped in the same direction regardless of whether the seal S is installed with its inner face IF or outer face OF oriented inwardly toward the housing internal region HR. It should also be noted that the seal S must be installed in the housing H such that the debris lip DL, if provided, is oriented outwardly away from the housing internal region HR so that it inhibits ingress of liquid and solid contaminates but does not impede the pumping action of the lubricant toward the housing internal region HR.

Another advantage of a seal S formed in accordance with the present development is that the seal S works well as a split seal that does not need to be bonded or otherwise require use of any adhesives after being installed. Unlike known seals, the seal S can be split for installation about a shaft T (see dashed line SX in FIG. 3), and once installed, the helical lip L becomes re-aligned with itself so that the helical lip functions as described above to pump lubricant in the inward direction DI along the helical path of the lubricant channel LC toward the internal region HR of the housing is indicated by the arrow DH in FIG. 7. This is a main advantage over standard known lip seals that are very problematic during use if they are split for installation about a shaft T. In accordance with the illustrated embodiment of the seal S, the slit or split SX forms first and second adjacent opposed split faces SX1,SX2 in the seal body B, and these split faces SX1,SX2 comprise respective structures that mechanically mate with each other when the first and second split faces SX1,SX2 are located adjacent each other when the seal S is operatively installed after being split to ensure that the split faces SX1,SX2 are properly realigned with each other when the seal S is operatively installed. In the illustrated embodiment, a connector such as a dowel DW or other projecting pin or structure is secured to the body B and projects outwardly from the first split face SX1 toward the second split face SX2, and the second split face SX2 includes a hole or bore BW or other mating structure that closely receives the projecting portion of the dowel DW or other connector structure with minimal clearance and with a snug friction fit to ensure that the split SX is properly closed and that the first and second split faces SX1,SX2 are properly aligned with each other and held adjacent each other, and that the helical lip L is properly reconstituted or restored to a continuous, uninterrupted helical lip after the seal S is split and then operatively installed about a shaft T as described. Unlike a single-lip seal, the present seal S will be effective to pump lubricant toward the housing internal region HR even if the helical lip L is not perfectly mated and matched when the first and second split faces SX1,SX2 are bonded or otherwise connected when the seal S is installed. It should also be noted that the seal S can be split by a user or supplied with the split SX, with the latter ensuring that the split SX is a high-quality split with uniformly shaped split faces SX1,SX2.

Because a seal S formed in accordance with the present development includes a helical lip L does not run with a single line of contact on the outer surface TS of the shaft T, the seal S can run on softer surfaces and the outer surface TS of the shaft T does not need require special grinding or polishing for the seal S to be effective.

FIGS. 8-11 disclose a seal S′ formed in accordance with an alternative embodiment of the present development. Except as otherwise shown and/or described herein, the seal S′ is identical to the seal S described above. Like structures of the seal S′ relative to the seal S are identified with like reference characters and are not all described again here. The seal S′ differs from the seal S in that it comprises two or more (a plurality) of flexible sealing lips L such as the first, second, and third flexible sealing lips 1L,2L,3L shown in the illustrated embodiment, but more (four or more) or less (two) flexible sealing lips L can be provided in accordance with this multi-lip embodiment. The flexible sealing lips 1L,2L,3L are arranged in the manner of a multi-start or multi-lead internal thread. Each lip L (i.e., 1L,2L,3L) thus comprises a respective outer edge OE connected to the inner wall IW of the body B. Each lip L projects inwardly from the inner wall IW toward the central longitudinal axis X and terminates at its respective inner edges IE that is spaced inwardly toward the central longitudinal axis X relative to the outer edge OE such that the inner edges IE define the cylindrical lip seal region LSR. Each lip L is preferably generally flat between its outer and inner edges OE,IE. The outer and inner edges OE,IE and the entire portion of each lip L located between the outer and inner edges OE,IE extends continuously and uninterrupted on an helical path centered on the central longitudinal axis X. The sealing lips L all travel helically about the central axis X with the same orientation/handedness/chirality (either right-handed as shown or left-handed) but the lips 1L,2L,3L are axially translated or offset relative to each other such a plurality of helically extending lubricant channels LC are defined between said inner wall and axially successive portions of said flexible sealing lips. Accordingly, in the illustrated embodiment: (i) a first helically extending lubricant channel LC1 is defined between the first and second lips 1L,2L; (ii) a second helically extending lubricant channel LC2 is defined between the second and third lips 2L,3L; and, (iii) a third helically extending lubricant channel LC3 is defined between the third lip 3L and the adjacent turn of the first lip 1L. As such, the number of lubricant channels LC1,LC2,LC3 equals the number of flexible sealing lips L (1L,2L,3L). The lips 1L,2L,3L are preferably evenly axially spaced from each other. As such, for a given axial spacing or “pitch” between the helical turns of each flexible sealing lip L, in use, the seal S′ will pump more grease or other lubricant in the inward direction DI toward the internal region HR of the housing H toward the bearing(s). In one embodiment, each lip 1L,2L,3L extends around the longitudinal axis X at least one (1.0) complete helical turn and preferably at least one-and-one-half (1.5) complete turns.

The development has been described with reference to preferred embodiments. Modifications and alterations will occur to those of ordinary skill in the art to which the invention pertains, and it is intended that the claims be construed as encompassing all such modifications and alterations to the maximum possible extent while preserving the validity of the claims.

1. A seal comprising:
a body comprising a rear face, a front face, an outer wall, and an inner wall that defines an opening in the body that is adapted to receive an associated shaft, said opening defined about a central longitudinal axis of the body;
at least one flexible sealing lip that is connected to the inner wall and that projects inwardly from the inner wall toward the central longitudinal axis, said at least one lip comprising an outer edge connected to the inner wall of the body and comprising an inner edge that is spaced inwardly toward the central longitudinal axis relative to the outer edge, said at least one flexible sealing lip extending helically about said central longitudinal axis.

2. The seal as set forth in claim 1, wherein said at least one helically extending flexible sealing lip defines a helically extending lubricant channel that is defined between said inner wall and axially successive lip portions of said at least one flexible lip.

3. The seal as set forth in claim 1, wherein said at least one flexible sealing lip comprises two or more flexible sealing lips that extend along respective helical paths that have the same orientation with respect to each other and that are axially offset with respect to each other and that are each centered on said central longitudinal axis.

4. The seal as set forth in claim 3, wherein said two or more helically extending flexible sealing lips define multiple helically extending lubricant channels that are each defined between said inner wall and axially successive lip portions of said two or more flexible sealing lips.

5. The seal as set forth in claim 4, wherein said at least one flexible sealing lip comprises three flexible sealing lips that extend along respective helical paths that have the same orientation with respect to each other and that are axially offset with respect to each other and that are each centered on said central longitudinal axis.

6. The seal as set forth in claim 1, wherein said at least one sealing lip is contained entirely within said opening of said body without projecting axially outward with respect to said front and rear faces of said body.

7. The seal as set forth in claim 6, wherein said at least one sealing lip is flat between said inner and outer edges.

8. The seal as set forth in claim 6, wherein said at least one sealing lip comprises first and second opposite ends, and wherein said first end of said at least one sealing lip is located within said opening closer to said rear face as compared to said front face, and said second end of said at least one sealing lip is located within said opening closer to said front face as compared to said rear face.

9. The seal as set forth in claim 6, wherein said body and said at least one flexible sealing lip are defined as a one-piece polymeric structure, and wherein said outer wall comprises a cylindrical surface that extends axially between the front and rear faces.

10. The seal as set forth in claim 9, wherein said inner wall comprises a cylindrical surface that is concentrically located with respect to said cylindrical surface of said outer wall and that extends axially between the front and rear faces.

11. The seal as set forth in claim 1, further comprising a circular debris lip connected to the inner wall between the front face and the at least one flexible sealing lip and projecting inwardly from the inner wall toward the central axis.

12. The seal as set forth in claim 6, further comprising a circular debris lip connected to the inner wall between the front face and the at least one flexible sealing lip and projecting inwardly from the inner wall toward the central axis.

13. A seal installation comprising:
a housing;
a shaft supported relative to the housing for relative rotation between the shaft and the housing about an axis of rotation;
said housing including a seal-receiving region coaxially located about the axis of rotation;
a seal installed in the seal-receiving region and coaxially located about the axis of rotation, said seal comprising:
a body comprising a rear face, a front face, an outer wall, and an inner wall that defines an opening in the body through which the shaft extends, said opening defined about a central longitudinal axis of the body;
at least one flexible sealing lip that is connected to the inner wall of the seal body and that projects inwardly from the inner wall toward the axis of rotation, said at least one flexible sealing lip comprising an outer edge connected to the inner wall of the body and comprising an inner edge that is spaced inwardly toward the axis of rotation and in contact with an outer surface of the shaft, said at least one flexible sealing lip extending helically about said central longitudinal axis;
said at least one flexible sealing lip defining a helically extending lubricant channel, wherein lubricant located in the lubricant channel is pumped toward an internal region of the housing away from the front face of the seal body upon relative rotation between the shaft and the housing.

14. The seal installation as set forth in claim 13, further comprising a seal retainer affixed to the housing adjacent the seal-receiving region that captures the seal body in the seal-receiving region.

15. The seal installation as set forth in claim 13, further comprising a flexible debris lip located between the front face of the body and the at least one flexible sealing, wherein said debris lip is connected to the inner wall of the seal body and projects inwardly toward the shaft and is in contact with an outer surface of the shaft such that said debris lip inhibits the ingress of contaminants into the lubricant channel.

16. The seal installation as set forth in claim 13, wherein said at least one flexible sealing lip comprises two or more flexible sealing lips that extend along respective helical paths that have the same orientation with respect to each other and that are axially offset with respect to each other and that are each centered on said central longitudinal axis.

17. The seal installation as set forth in claim 16, wherein said two or more helically extending flexible sealing lips define multiple helically extending lubricant channels that are each defined between said inner wall, said shaft, and axially successive lip portions of said two or more flexible sealing lips.

18. The seal installation as set forth in claim 13, wherein said at least one sealing lip is contained entirely within said opening of said body without projecting axially outward with respect to said front and rear faces of said body.

19. The seal installation as set forth in claim 13, wherein said body and said at least one flexible sealing lip of said seal are defined as a one-piece polymeric structure.

20. The seal installation as set forth in claim 19, wherein said body comprises a split that extends through said front and rear faces and through said inner and outer walls.
